(19) United States
(12) Patent Application Publication
(10) Pub. No.: US 2005/0205700 A1
(43) Pub. Date: Sep. 22, 2005

(54) Waste disposal processing system and method

(76) Inventor: Clarence W. Smith, Fallon, NV (US)

Correspondence Address: SIERRA PATENT GROUP, LTD., P O BOX 6149, STATELINE, NV, 89449, US

(21) Appl. No.: 10/859,592

(22) Filed: Jun. 1, 2004

Related U.S. Application Data
(60) Provisional application No. 60/553,914, filed on Mar. 16, 2004.

(51) Int. Cl. B02C 19/12

(52) U.S. Cl. 241/21; 241/101.2

(57) ABSTRACT

A waste processing method comprises shredding a batch of waste to produce shredded waste; grinding the shredded waste in a volume of water in a grinder to produce a mixture of ground waste particles and water; straining the mixture of ground waste particles and water; returning to the grinder the water and the ground waste particles having sizes larger than a extracting residual water from the ground waste particles having sizes smaller than the selected size; returning the residual water to the grinder; and drying the ground waste particles having sizes smaller than the selected size.

### CROSS-REFERENCE TO RELATED APPLICATIONS

This application claims the benefit of U.S. Provisional Application Ser. No. 60/553,914, filed Mar. 16, 2004.

### BACKGROUND

The present disclosure relates to a system for processing waste. In particular, the present disclosure relates to a system for processing waste by reducing volume and producing a usable byproduct.

Communities produce large volumes of waste each and every day. The waste produced is disposed of in many ways. In most communities, the waste (i.e., household waste) is deposited into plastic garbage bags and then temporarily stored in a garbage can. The garbage can is periodically placed at a curbside for removal by the local waste removal service. The waste removal service collects the community waste into larger trucks and compacts the waste to a certain degree. The waste is then transported to a waste collection facility for further processing or transported directly to a local landfill. The processed waste can be separated and sorted into various types of waste prior to transportation to a landfill.

In other prior art waste removal techniques, the waste is transported to a waste incinerator. In other prior art waste removal techniques, the waste is packaged onto barges, shipped offshore and dumped into the ocean.

In the prior art waste processing techniques, the waste is not efficiently reused. The landfills are rapidly becoming full and will no longer be a viable solution to waste removal. The incineration techniques are environmentally harmful, are not cost effective, and require government subsidies to operate. The ocean dumping is detrimental to the ocean environment and the extent of damage to the earth's oceans has yet to be completely understood.

What is needed in the art is a waste disposal processing system that efficiently processes waste and provides a useful byproduct.

### SUMMARY

A waste processing system comprises a waste loader configured to receive waste. A shredder is coupled to the waste loader. The shredder includes at least one blade disposed in a shredder housing. The shredder is configured to shred and reduce waste into a refined composition. A grinding tank is disposed downstream of the shredder. The grinding tank is configured to further reduce the particle size of the waste by use of mechanical agitation and impact between grinding elements and the waste within an aqueous solution disposed in the grinding tank. A screen is disposed downstream of the grinding tank. The screen separates the waste composition based on particle size. The screen is configured to drain away the water for reuse in the grinding tank. A water extractor is coupled to the screen and is configured to further extract moisture from the waste composition. A drying tunnel and shaker table is coupled to the water extractor. The drying tunnel and shaker table is configured to remove additional moisture and air trapped in the waste composition.

According to another aspect of the present invention, the powdered waste may be mixed with a binder material and may then be cast into blocks. The cast blocks have useful properties and may be used for construction and decorative applications.

### DESCRIPTION OF THE DRAWINGS

FIG. 1 is a perspective view of exemplary waste disposal processing system.

FIG. 2 is front view of an exemplary waste disposal processing system.

### DETAILED DESCRIPTION

A waste disposal processing system is disclosed. The waste disposal processing system includes a waste loader configured to receive waste and load the waste into a shredder. The shredder shreds and reduces the waste into a refined composition. The waste disposal system includes a grinding tank downstream of the shredder. The grinding tank is configured to further reduce the particle size of the waste by use of mechanical agitation and impact between grinding elements and the waste within an aqueous solution in the grinding tank. The waste composition is further processed through a screen located downstream of the grinding tank. The screen separates the waste composition based on the particle size. The water is also drained away for reuse in the upstream grinding tank. A water extractor is coupled to the screen and is configured to further extract moisture from the waste composition. A drying tunnel and shaker table is located downstream of the water extractor. The drying tunnel and shaker table remove additional moisture and air trapped in the waste composition. A powdered solid material remains as a useful byproduct having a significant reduction in volume from the original waste disposed in the waste disposal processing system.

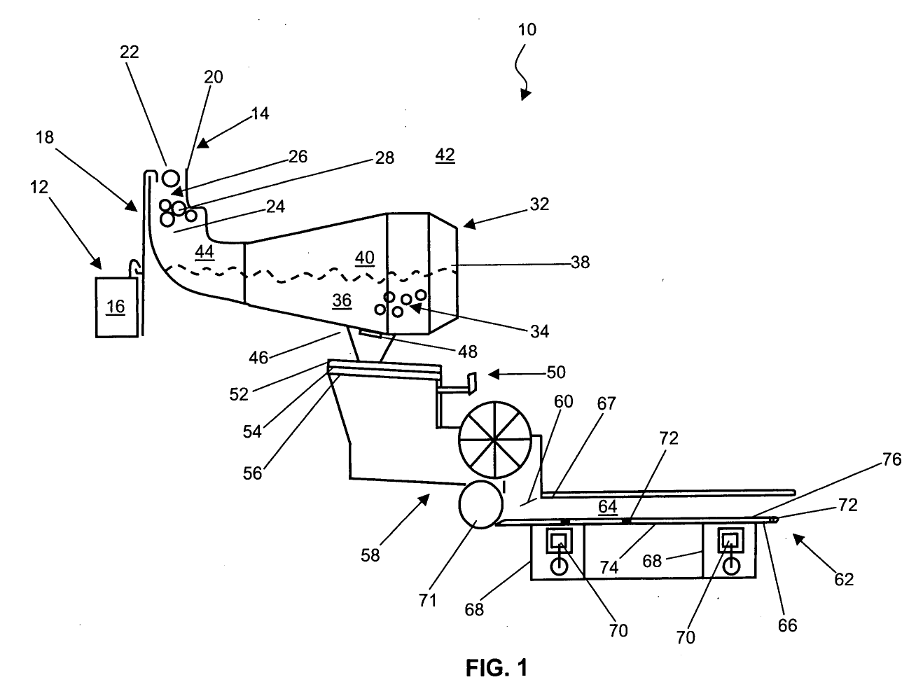

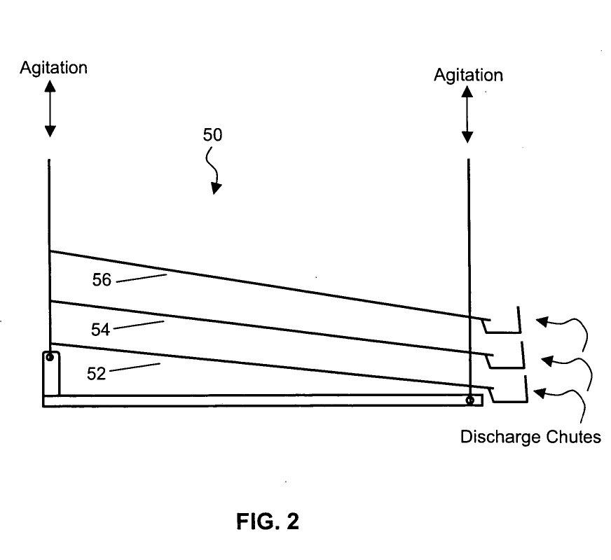

Referring to FIGS. 1, and 2, exemplary embodiments of the waste disposal processing system are illustrated in a schematic and perspective view, respectively. The waste disposal processing system 10 includes a waste loader 12 configured to receive waste and load the waste into a shredder 14. The waste loader 12 can include a container 16 configured to receive and contain waste. In an exemplary embodiment, the container can be sized with and opening about 28 inches by 22 inches and about 38 inches high. It is contemplated to provide variations in the dimensions.

The waste loader 12 can include a lift 18. The lift 18 is configured to elevate the container and reorient the container 16 in order to empty the waste from the container 16 into the shredder 14. The container 16 can clip to the lift via a spring-loaded clip (not shown), and variants thereof. In an exemplary embodiment, the lift 18 can comprise a chain driven by a 12Volt DC motor (not shown). The motor can also be a variable speed motor of multiple sizes depending on the size of the container 16. In the exemplary embodiment illustrated, the waste loader 12 is configured to receive waste in the container 16. The lift 18 raises the container 16 up to the shredder 14 and turns the container 16 over to empty the contents of the container 16 into the shredder 14. The lift 18 returns the container 16 to a position ready for receiving additional waste. The container 16 can also be manually operated in other embodiments. The container 16 can be constructed of plastic, metal, wood, combinations thereof, and the like. It is contemplated that the waste loader 12 can include manual or automatic instrumentation and controls for ease of operation.

The shredder 14 shreds and reduces the waste into a refined composition. The shredder 14 includes a shredder housing 20 having an inlet 22 and outlet 24. In an exemplary embodiment, the shredder housing 20 can be about 28 inches wide by about 22 inches wide and about 36 inches deep. The shredder housing 20 can comprise hard materials, such as, ⅛ inch steel plate, plastic, wood, aluminum, copper, brass, screen, mesh, and galvanized sheet metal, and the like.

The shredder 14 includes a plurality of blades 26 configured to shred waste in the shredder 14. The blades 26 can be configured into a pattern of outlet rows 28 arranged as four rows of blades oriented with each blade axis perpendicular to the depth of the shredder housing 20 and aligned along the long width of the shredder housing 20. In a non-limiting exemplary embodiment, each blade 26 is a disc of about 7.25 inches in a circular saw blade configuration. The size and number of teeth on each blade 26 can be varied. Each row of blades 26 can comprise, for example, 52 blades.

In an exemplary embodiment, the four rows of blades 28 can be located about 12 inches from the outlet 24. The blades 26 can overlap. In an exemplary embodiment, the blades 26 can overlap by about 3.5 inches. An inlet row 30 set of blades can be located proximate the inlet 22. In an exemplary embodiment, the inlet row 30 can comprise 2 rows of blades 26 located about 6 to about 12 inches from the inlet 26 in the shredder housing 20. In an exemplary embodiment, all blades 26 can be mounted on a shaft or rod about ⅜ inches. The blades 26 can be space apart by about ½ inch for the outlet rows 28 and about 2 inches for the inlet rows 30. In an exemplary embodiment, the inlet blades 30 can be spaced apart equally to fill the available space. In another exemplary embodiment, there are two rows of thirteen inlet blades 30.

In other embodiments, the shedder 14 can include mill stones, grinding rocks of various hardness, solid metal wheels, grinding discs, cutting discs, sand paper, hardwood of oak, and pecan, and the like. In an exemplary embodiment, the shredder blades 26 can operate at about 1800 rpm and be driven by, for example, a 2-horsepower electric motor or a 5-hp gasoline engine. In a preferred embodiment, the shredder 14 is configured to shred the waste into about a ¼ inch diameter size for minimum grinding time. The waste can be reduced to about 55% to 65% of original volume when being discharged from the outlet 24. It is contemplated that the shredder 14 can reduce the waste to a larger size and with lower volume reductions, while creating a longer grinding process to occur.

The waste disposal system includes a grinding tank 32 downstream of the shredder 14. The grinding tank 32 is configured to further reduce the particle size of the waste by use of mechanical agitation and impact between grinding elements 34 and the waste within an aqueous solution 36 in the grinding tank 32. The grinding tank 32 includes a tank wall 38 defining an interior 40 and an exterior 42. The grinding tank 32 includes an inlet 44 and an outlet 46. The inlet 44 is proximate the outlet 24 of the shredder 14 and is configured to receive the waste from the shredder 14. The processed waste is discharged from the outlet 24 of the shredder 14.

The tank wall 38 is coupled to a rotary mechanism (not shown) and is configured to rotate in order to agitate the waste and the grinding elements 34 in the interior 40. The grinding elements 34 can comprise about 2 inch to about 3 inch diameter grinding balls. It is contemplated that the grinding elements 34 can comprise various types of grinding materials, such as, sand, gravel, rocks, scrap metal, bricks, hard wood, chipped concrete, aluminum, brass, copper, and the like. The process can also include high pressure steam and water jets, high pressure sand, and the like. A volume of water is added to the grinding tank 32 to promote the grinding process. The amount of water and grinding elements 34 added to the grinding tank 32 depends on the processing time and quality of grinding desired. In a preferred embodiment the grinding time should be about 30 minutes and the quality of shredding, water and grinding elements can be adjusted appropriately.

The tank wall 38 can comprise, for example, a cement-mixing tank. The rotary mechanism can be the power takeoff of the cement-mixing tank. The tank may be portable and may be mounted, for example, on a multi-axle truck chassis. The grinding tank 32 can rotate at about 18 rpm to about 60 rpm. The rate of rotation can vary depending on the process speeds desired. The tank wall 38 can be configured in a 18 inch by 18 inch grinding tank by a predetermined length. The tank wall 38 can be ½ inch sheet metal. In alternate embodiments the tank wall 38 can comprise plastic, copper, brass, aluminum, galvanized sheet metal, and the like. The inlet 44 can be about 30 inches in diameter.

In an alternate embodiment, the grinding tank 32 can comprise a flow-through style arrangement. Instead of a closed container, the tank wall can comprise an open-ended tube or pipe with the waste material flowing through from the inlet to the outlet. The grinding elements 34 can comprise rods or long tubes that impinge on the material but remain inside the tank wall interior 40. The tank wall 38 outlet 46 includes a lid 48 that is removable and configured to contain the waste and water mixture during grinding and allow for discharge of the waste with the retention of the grinding elements 34. The lid 48 can comprise a solid plate and a screen mesh that can be interchangeable during processing. The solid plate and screen can also be integral.

The waste composition is further processed through a screen system 50 located downstream of the grinding tank 32. The screen system 50 separates the waste composition based on the particle size. The water is also drained away for reuse in the upstream grinding tank 32.

In an exemplary embodiment illustrated in FIG. 2, the screen system 50 can comprise a series of screens as is known in the art. For example, three screens 52, 54, 56 having varying mesh dimensions for segregating the materials based on size with the larger size above the smaller size in series may be used. In an exemplary embodiment, screen 52 can be a 10-mesh screen, screen 54 can be a 20-mesh screen, and screen 56 can be a 28-mesh screen. It is contemplated that any number of screens can be employed. The screen 50 can be agitated by an agitator, such as a motor (not shown). Screens 52, 54, and 56 may be disposed at an angle as known in the art and discharge chutes may be provided to return particles that do not pass through screens 52, 54, and 56, as well as most of the water, to the grinding tank 32.

The agitation motor can operate at about 1800 rpm. The speed of the motor and thus the agitation can be varied. In an exemplary embodiment, the displacement of the screen agitation can be from about 2 inches to about 3 inches. In an exemplary embodiment, the screen 50 can be rectilinear measuring about 4 feet by about 6 feet. The screen 50 can comprise a stainless steel placed into a wrap around deck of about ¼ inch by 2 inches angle iron. The deck and screen material can comprise plastic, iron, copper, brass, aluminum, wood, galvanized sheet metal, and the like. The deck and screen can be any size and configuration. The waste material can drain by gravity through the screen 50 to a water extractor 58.

The water extractor 58 is coupled to the screen 50 and is configured to further extract moisture from the waste composition. An exemplary water extractor 58 suitable for use in the present invention is a dewatering drum filter, such as those available from Dorr-Oliver Eimco of Salt Lake City, Utah. The water extractor 58 is used to extract as much water as possible from the waste materials. The water extractor 58 draws the water off the waste material through fine mesh with vacuum or pump suction, that varies based on the density of the material. The water is pumped back to the grinding tank 32 for reuse. The dewatered material is dropped to a drying pad 60 below for further processing. The water extractor 58 can comprise a stainless steel, copper, brass, aluminum, plastic, and the like. The water extractor 58 can operate at variable speeds as well constant speed depending on the density of the material processed.

A drying tunnel and shaker table 62 is located downstream of the water extractor 58. The drying tunnel and shaker table 62 remove additional moisture and air trapped in the waste composition. In exemplary embodiments, at least one drying pad 60 receives the waste composition downstream of the drying tunnel and shaker table 62 for the final curing and hardening of the waste composition.

The drying tunnel 64 can be, for example, about 15 feet in length and about 4 feet wide and located over the shaker table 66. A cover 67 can be included over the table and be set at a minimum of about 24 inches from the shaker table. The cover can comprise, for example, a 10 gauge galvanized sheet metal although other materials can be used. The shaker table 66 can comprise two hollow legs 68 centrally located at the shaker table 66. Pistons 70 are disposed within the hollow legs 68 and are configured to agitate the table and contents thereon. In an exemplary embodiment, the legs 68 can be about 3 inches in diameter and the pistons 70 can be about 2 inches in diameter and comprise a solid rod material. A motor, such as a 3-hp motor (not shown) can be coupled to each piston 70 via a 6 inch piston plate. The motors can be mounted on the floor directly in line with the legs 68. The piston plate can include adjustment holes for speed adjustment. The connector rod from the piston plate can be a solid rod including a pivot pin about 6 inches up on the rod connected to the piston plate. The motor can operate at about 1800 rpm. The table is configured to be vertically displaced from about 1 inch to about 3 inches.

Rubber grommets 72 can be employed with the table between a stationary frame 74 and moveable table deck 76. In an exemplary embodiment, eight grommets 72 can be employed in an equally spaced pattern and attached to the frame and configured for shock absorption. The table frame 74 can comprise a ¼ inch by 3 inch angle iron and the movable table deck 76 can comprise a ¼ inch sheet metal decking. The frame 74 and decking 76 can be welded. In other exemplary embodiments, the table can comprise wood, sheet metal, copper, brass, stainless steel, aluminum, galvanized sheet metal, and the like. The drying tunnel and shaker table 62 can include blowers 78 fluidly coupled to the drying tunnel 64 at an end proximate the material input end of the table. The blower can be about 11,000 CFM or greater.

The drying pad 60 can be included and located to receive the materials after the drying tunnel and shaker table 62 or after the water extractor 58. The drying pad 60 can be large enough for one week of waste material processing. The drying pad 60 can be about 100 feet by 100 feet in size. The drying pad 60 can comprise concrete material and include sealed surfaces and containment barriers for the prevention of material leakage. Finger type agitators and ambient air can also be employed in the drying process.

A powdered fibrous material remains as a useful byproduct having a significant reduction in volume from the original waste disposed in the waste disposal processing system. As has been disclosed herein, all of the waste material that is not processed into a byproduct is returned to the grinding tank 32. A single-component waste material, such as glass, or soft metals such as aluminum, may be processed according to the techniques of the present invention.

According to another aspect of the present invention, the powdered material that remains can be used for counter tops, wall tile, floor tile, patio pavers, table tops, artistic painting, paint pigmentation, decorative wall paint, cement filler mixture, and wall insulation and the like. The powdered material is mixed with a binder material such as latex, patch cement, tile grout, etc. According to one embodiment of this aspect of the invention, approximately equal amounts of the powdered byproduct and binder may be mixed with water and set in a mold. Too much water will adversely affect drying time and will also affect the quality of the final product (e.g., produce soft spots or discoloration on the top of the drying casting). It has been found that about 5.7 ounces of water per pound of material is satisfactory. Drying time depends on ambient temperature and humidity. Ideal temperature has been observed to be between about 70° to about 80° F.

While embodiments and applications of this disclosure have been shown and described, it would be apparent to those skilled in the art that many more modifications than mentioned above are possible without departing from the inventive concepts herein. The disclosure, therefore, is not to be restricted except in the spirit of the appended claims.

1. A waste processing method comprising:
shredding a batch of waste to produce shredded waste;
grinding said shredded waste in a volume of water in a grinder to produce a mixture of ground waste particles and water;
straining said mixture of ground waste particles and water;
returning to said grinder said water and said ground waste particles having sizes larger than a selected size;
extracting residual water from said ground waste particles having sizes smaller than said selected size;
returning said residual water to said grinder; and
drying said ground waste particles having sizes smaller than said selected size.

2. The waste processing method of claim 1 wherein grinding said shredded waste in a volume of water in a grinder to produce ground waste particles comprises grinding said shredded waste in a ball mill grinder.

3. The method of claim 1 wherein straining said ground waste and said water comprises straining said ground waste and said water through a plurality of screens.

4. The method of claim 3 wherein a fine one of said screens is a 10-mesh screen.

5. The method of claim 3 wherein straining said ground waste and said water comprises straining said ground waste and said water through first, second, and third screens.

6. The method of claim 3 wherein straining said ground waste and said water comprises straining said ground waste and said water through a first screen having about 28 mesh, a first screen having about 20 mesh, and a third screen having about 10 mesh.

7. The method of claim 3 wherein straining said ground waste and said water further comprises agitating said screens.

8. The method of claim 1 wherein extracting residual water from said ground waste particles water extractor comprises employing a water extractor.

9. The method of claim 1 wherein drying said ground waste particles comprises passing said ground waste particles through a drying tunnel on a shaker table.

10. A waste processing system comprising:
a shredder including at least one blade disposed in a shredder housing;
a grinding tank coupled to said shredder, said grinding tank including a plurality of grinding elements and adapted to receive shredded waste from said shredder and a volume of water;
a straining system coupled downstream of said grinding tank, said straining system separating ground waste based on particle size, said straining system configured to drain away said water for reuse in said grinding tank;
a water extractor coupled to said straining system and configured to further extract moisture from the ground waste;
a drying tunnel and shaker table coupled to said water extractor, said drying tunnel and shaker table configured to further dry the ground waste.

11. The waste processing system of claim 10 wherein said grinding tank is configured as a ball mill.

12. The waste processing system of claim 10 wherein said grinding tank is configured as a rod mill.

13. The waste processing system of claim 10 wherein said screening system comprises a plurality of different mesh-size screens.

14. The waste processing system of claim 10 wherein said screening system further includes an agitator coupled to said screens.

15. The waste processing system of claim 13 wherein said screening system comprises at least three different mesh-size screens.

16. The waste processing system of claim 15 wherein said at least three different mesh-size screens comprise a first screen having about 28 mesh, a first screen having about 20 mesh, and a third screen having about 10 mesh.

17. The product of the process of claim 1 mixed with a substantially equal part of a binder and water and molded into a block.

18. The product of claim 17 wherein said binder is chosen from the group comprising, cement, latex and grout.

19. The process of claim 1 further including molding said ground waste particles having sizes smaller than said selected size with a binder and water to form a block.

20. The process of claim 1 wherein molding said ground waste particles having sizes smaller than said selected size with a binder and water to form a block comprises molding with a binder chosen from the group comprising, cement, latex and grout.
